(19) United States
(12) Patent Application Publication
(10) Pub. No.: US 2008/0049961 A1
(43) Pub. Date: Feb. 28, 2008

(54) Personal audio player

(76) Inventor: Thomas J. Brindisi, Venice, CA (US)

Correspondence Address: Thomas J. Brindisi, Esq., Suite B, 20 28th Place, Venice, CA, 90291, US

(21) Appl. No.: 11/510,423

(22) Filed: Aug. 24, 2006

(51) Int. Cl. H04R 25/00

(52) U.S. Cl. 381/380; 381/370

(57) ABSTRACT

A personal audio player system comprising a first earpiece having a body, an anchor attached to the body and shaped to fit a human ear, an onboard audio speaker, onboard persistent memory capable of storing multiple songs, an onboard power source, onboard interface controls, and onboard electronic circuitry comprising an interface module and an audio playback module. In an optional embodiment, the system may further comprise a second earpiece that has a body, an anchor attached to the body, and an onboard audio speaker. In one of a number of variations of that optional embodiment, for example, the second earpiece may also include its own onboard persistent memory from which it can play the same content as, and in synchronicity with, the first earpiece, further optionally aided by the transmission of synchronization signals from the first earpiece.

### FIELD OF THE INVENTION

The present invention relates primarily to the field of personal audio devices, and more particularly, to a personal audio player.

### SUMMARY OF THE INVENTION

A personal audio player system according to the present invention comprises a first earpiece having a body, an anchor attached to the body and shaped to fit a human ear, an onboard audio speaker, onboard persistent memory capable of storing multiple songs, an onboard power source, onboard interface controls, and onboard electronic circuitry comprising an interface module and an audio playback module. In an optional embodiment, the system may further comprise a second earpiece that is a slave and has a body, an anchor attached to the body, and an onboard audio speaker. In one of a number of variations of that optional embodiment, for example, the slave earpiece may also include its own onboard persistent memory from which it can play the same content as, and in synchronicity with, the first earpiece, further optionally aided by the transmission of synchronization signals from the first earpiece.

### BRIEF DESCRIPTION OF THE DRAWINGS

FIG. 1 is a sectional view of a first earpiece according to an embodiment of the present invention.

FIGS. 2, 3, and 4, respectively, are an outer side view, front view, and top view of the first earpiece shown in FIG. 1.

FIGS. 5 and 6, respectively, are an outer side view and a top view of a slave earpiece for use with the first earpiece shown in FIGS. 1-4.

### DETAILED DESCRIPTION OF A PREFERRED EMBODIMENT

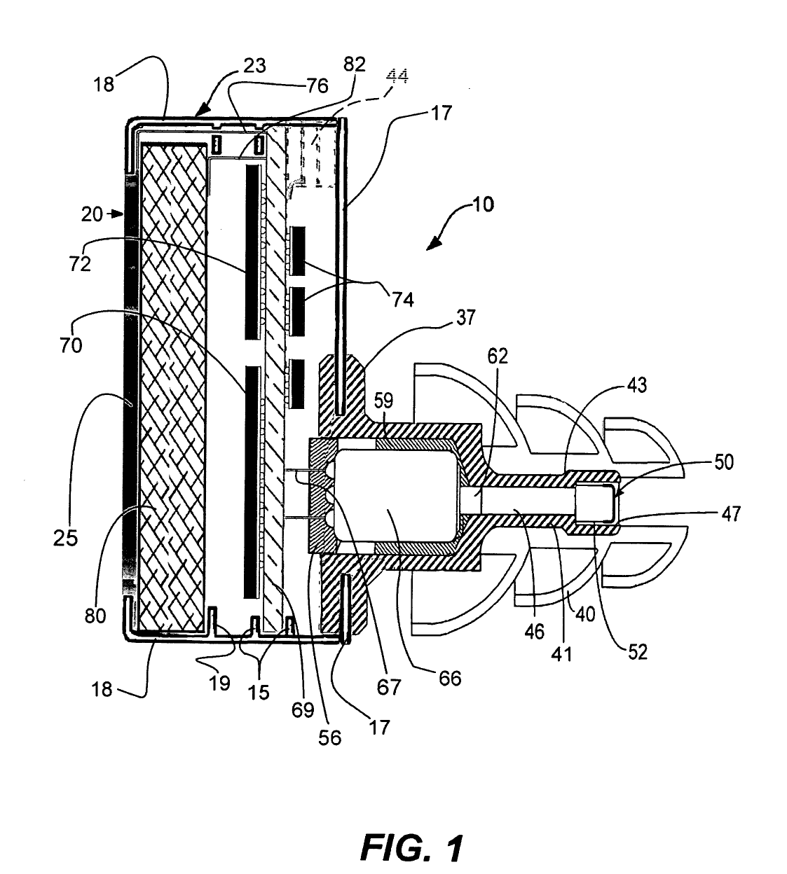

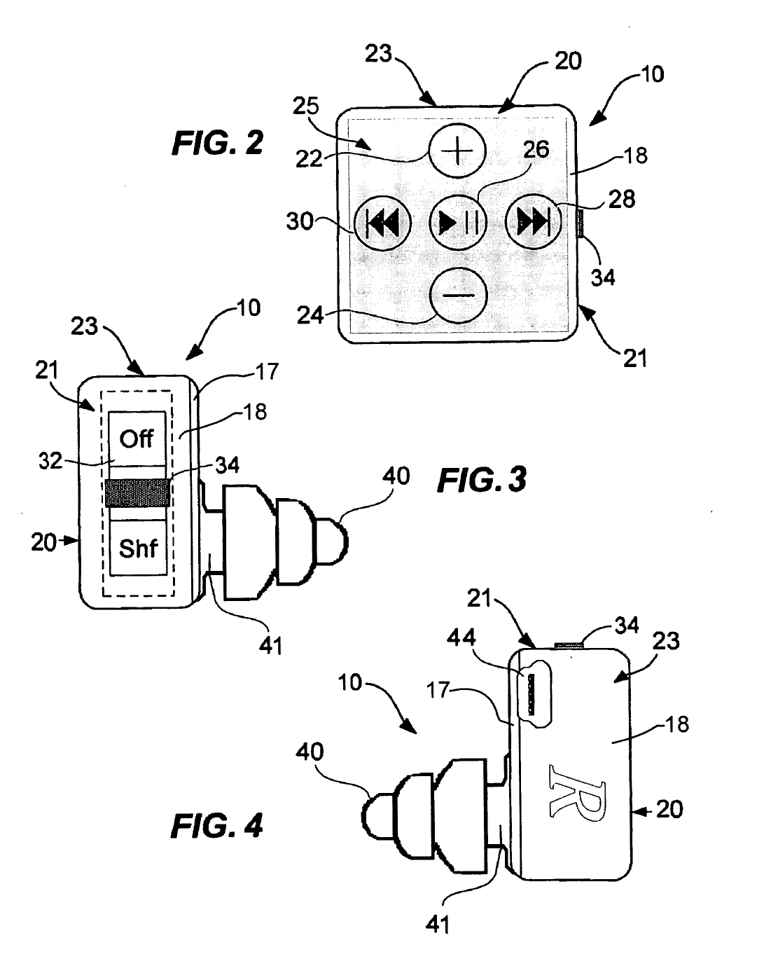

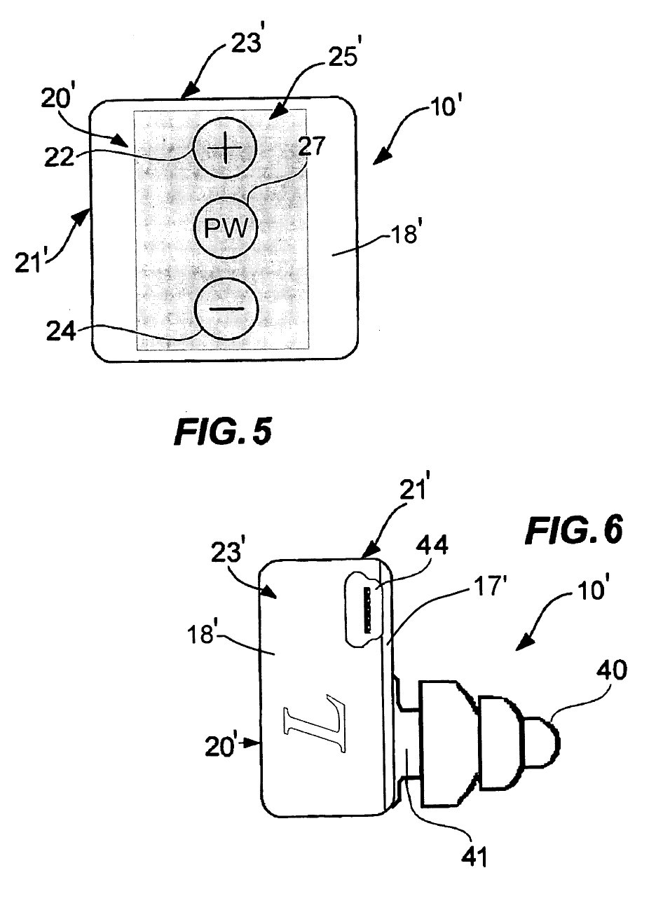

FIGS. 1-4 depict a first, master earpiece 10 of a preferred embodiment of a personal audio player according to the present invention, and FIGS. 5-6 depict a second, slave earpiece 10′ of that embodiment. The earpieces 10 and 10′ each include a body generally comprising housing base 17, housing shell 18, and molding 41, and each include an ear canal anchor 40 attached to the molding 41 and an onboard speaker 66 generally within it. Each earpiece 10 and 10′ further includes an onboard memory 70 (e.g., a NAND Flash memory such as Samsung Part No. K9F2G08U0A—2 Gb SLC/Large Block, 2.7˜3.6V, 25 ns speed, in a 10 mm×13 mm×1.0 mm 63FBGA package, or alternately Samsung Part No. K9K1G08B0B—1 Gb SLC/Small Block, 2.5-2.9V, 50 nS, 8.5 mm×13.5 mm×1.2 mm 63FBGA), an onboard battery 80 (e.g., PowerPlus Tech. Co., Ltd. of Shenzhen, China's 3.7V lithium polymer model no. 302023—100 maH, 22.7 mm×19.5 mm×2.7 mm, or alternately for a more rectangular shape model no. 351624-110 maH, 24 mm×16 mm×3.5 mm; alternately a circular or other shape could be used), onboard interface controls on outer face 20 or 20′ comprising control pad 25 or 25′ with volume up control 22 and volume down control 24, with earpiece 10 further including play/pause control 26, forward control 28, and reverse control 30, as well as slider control (off/continuous play/shuffle) 32 on front face 21 with a knurled button 34, while earpiece 10′ only further includes slave on/off control 27. (A variety of alternate control options will be readily apparent, such as pressure-sensitive squeeze controls placed on opposing top/bottom faces or front/rear faces, etc.). Each earpiece 10 and 10′ also includes onboard circuitry comprising a controller 72 (preferably a high-speed, high-density, e.g., 0.18 μm or smaller, compact ASIC; alternately a microcontroller or FPGA) and other circuitry 74 (e.g., power supply regulation circuitry, an IC charger such as an Advanced Analogic Techs. of Sunnyvale, Calif.'s 3 mm×3 mm Model No. AAT3687, etc.) attached to circuit board 69. Each earpiece 10 and 10′ also includes data I/O and charging port 44 (preferably a USB mini-b or other suitable compact receptacle) on top face 23 or 23′.

The portion of the assembly comprising the molding 41, speaker 66, ear canal anchor 40, and associated parts and features can with minor adaptations be constructed generally as described in Etymotic, Inc.'s U.S. Pat. No. 5,887,070, the teachings in that regard of which are incorporated herein by reference. In summary, referencing FIG. 1 in particular, that portion of the assembly includes compressed foam 59 between speaker 66 and molding 41, a speaker output port 62 leading to a passage 46, with a cylindrical cap 52, acoustic damper and screen 50, and eartip shoulder 43 adjacent molding eartip 47. Other suitable ear canal anchors could be used instead of the depicted three-ribbed anchor, such as “earbuds,” or the foam eartip disclosed in U.S. Pat. No. 4,852,683, the teachings of which pertaining to said eartip are incorporated herein by reference, and/or ear anchors such as the popular wraparound bluetooth cellphone style could also be used. Also (not shown), molding base 37 may be provided with an extension(s), such as fully circumferentially (or in the form of two or more radial opposing spokes) around the radially remote portion of molding base adjacent the user's ear, to provide a backstop that impinges on the outer portion of the user's ear when too much inward force is applied on the earpiece, preventing the anchor from moving inwardly too far within the ear canal. Alternately, housing base 17 and 17′ could be provided with a backstop adapted to the ear.

Housing base 17 and 17′ and housing shell 18 and 18′ may be plastic, or preferably, a rigid, lightweight metal, and 17 may be insert-molded within (as shown in FIG. 1) or otherwise suitably attached to molding base 37. The mechanical construction of the portion of the assembly contained within the housing of each earpiece 10 and 10′ will be described with respect to earpiece 10 as depicted in FIG. 1, since in this preferred embodiment the construction can be essentially the same for each except for orientation. Housing shell 18 is preferably in the shape of a square or rectangular, or alternately circular, pan, with control pad 25 attached or incorporated by suitable means (e.g., insert molding, glue, crimping, etc.) into the outer face 20 of housing shell 18, and may be coated with an ergonomically suitable polymer. Control leads 76 are attached to control pad 25 and (in earpiece 10 only, though not shown in FIG. 1) to slider control 32. Onboard battery 80 is snapped into place in the housing shell 18 underneath battery boss 19, which (depending on the particular configuration, materials, and dimensions) may extend circumferentially around selected parts or most of the interior of housing shell 18, with passages and/or cut-outs provided to accommodate leads the and slider control 32; alternately, instead of or in addition to an interior boss, onboard battery 80 could be glued, crimped, locked, or otherwise suitably secured in place. Power leads 82 are connected to onboard battery 80. Circuit board 69, which is preferably double-sided and has attached to it onboard memory 70, controller 72, and other circuitry 74, is connected to control leads 76 and power leads 82, snapped into board bosses 15 (alternately and/or crimped, glued, locked down such as by housing shell 18 and/or extensions thereof, or secured using any other suitable means), and data I/O and charging port 44 is attached to the circuit board 69 and housing shell 18. Circuit board 69 may preferably be partly encapsulated with a suitable polymer to protect its circuitry and connections from jarring, vibration, and/or undesired contact with other components of the earpiece, and/or a foam layer could be placed adjacent one or both sides of the circuit board. After the internal components have been connected and inserted in housing shell 18 and speaker leads 67 leading out of resilient foam 56 have been attached to circuit board 69, housing base 17 may then be crimped, glued, welded, or otherwise suitably affixed to housing shell 18.

In the presently described embodiment, the master and slave circuitry each saliently comprise an interface control module, an I/O module, power regulation and charging modules, an audio playback module, and a synchronization module, and both earpieces include onboard memory in which audio content is to be stored for playback. Both earpieces are preferably loaded with the same audio content (as explained below), which is preferably played back by the slave earpiece 10′ in synchronicity (preferably within about 10 ms or so—human hearing perceives two sounds as coherent if they arrive within 30 ms) with playback of that content by the master earpiece 10. Thus the audio playback circuitry is preferably designed to provide a reasonably consistently, accurate playback speed up until a minimum battery level is reached (at which point the unit stops playing) as known in the art. Preferably, however, both the master earpiece 10 and slave earpiece 10′ further include an onboard transceiver (e.g., a low-power RF unit such as Texas Instruments/Chipcon Products' 4 mm×4 mm Model No. CC1150 or similar but lower-frequency and/or lower-power transceiver, preferably adapted for compatibility with the protocol described below) on circuit board 69. In that case the master earpiece circuitry is configured to transmit synchronization signals (generated by the master's synchronization module based on time of playback information obtained from the audio playback module) to the slave earpiece, and the slave earpiece circuitry is preferably configured to immediately transmit a confirmation signal in response to successful receipt of the master's synchronization signal. The master earpiece circuitry can then be configured to immediately re-transmit the signal if an error message is received from the slave or no confirmation is received within a certain period of time, and preferably to only implement a user command on the master earpiece side once confirmation is received from the slave.

The synchronization signals in such an embodiment may be communicated in a protocol that is uniform for user commands, timing, and confirmation. For example, a packetized structure could be used with each packet comprising digitized words of pre-selected length representing the following: transmitting earpiece ID; signal type (e.g., “TIMING” (which in some embodiments could be used for incremental forward and reverse commands), “CONF”, “PLAY”, “PAUSE”, “FWD”, “FWD SONG”, “REV”, “REV SONG”, “VOL UP”, “VOL DN”, etc.); ID number of the audio piece currently being played back or queued; current time of progress of playback of the audio piece (e.g, in microseconds); and an error check (e.g., CRC). The master's circuitry synchronization module may be configured to send timing signals periodically (e.g., every ten seconds) during playback when playback has not been interrupted by a user command, and to send command signals immediately whenever a control is activated by the user. (The interface control circuitry may preferably be configured to respond to user activation in discrete increments for volume and forward/reverse that are large enough—e.g., one-twentieth volume adjustments every quarter-second, and five-second audio content playback skips every half second—so that the repeated processing, signaling to the slave, processing and confirmation by the slave, and implementation that is incurred by maintained pressing of such controls can be accomplished at adequately fast intervals without unduly imposing on the transceiver bandwidth, processor/energy demands, clock speeds, etc.). The slave's synchronization module is then preferably configured to immediately send confirmation signals in response to command and timing signals. The slave's synchronization module preferably includes a time comparison function that compares the playback time from the synchronization signal to the playback time obtained from the slave circuitry's audio playback module (preferably using lighter weight processes of those known in the art) and that then, if the difference between them exceeds a predetermined limit (e.g. 10 ms), causes the slave's audio playback module to incrementally forward, reverse, or skip to the appropriate playback time in order to match that of the master. Although a delay will exist between the sending of a synchronization signal specifying a particular time (e.g., 0.000 s/start now) and the receiving and processing of, and acting on, that signal, such delays (specific to different signal types) are characteristic to the circuitry and can be quantified through (preferably empirical) testing of a given design. Thus the circuitry (including its code and/or protocol) can be calibrated appropriately, with manufacturing tolerances, quality components, and quality controls being applied to minimize drift and its effects and otherwise enhance the integrity of the designed-in calibration.

In a preferred embodiment of loading the onboard memories in the embodiment described above, a personal computer can be provided with software that is configured to interact with each earpiece one after the other, via USB connection. The software preferably identifies a list of audio pieces stored on the computer (which list can be limited and manipulated by the user) as is well-known in the art, and label each one with a unique audio piece ID number. The earpieces are preferably configured to be recognized by the computer, and when the software is running and an earpiece is connected, the software queries the earpiece through its I/O module for a sequential readback of the ID numbers of all audio pieces stored thereon (which can be stored in a separate table in the earpiece's memory). It then compares that list to the list of audio pieces on the computer, prompting the user to initiate downloading to the earpiece if it does not include all pieces on the computer's list, otherwise, prompting the user to make any desired changes to the contents of the list on the earpiece, or else to disconnect the earpiece and connect the other earpiece if necessary. Optionally, the software could determine whether connection of the other earpiece is necessary by storing the last saved list for each earpiece in memory on the computer, and comparing that list to the list just obtained (and/or modified) from the connected earpiece. (Alternately, the software could be configured to recognize both earpieces connected simultaneously, and interact with them concurrently). As another option, the software can include a module to convert various formats of encoded audio files into wave format (.wav), and download all audio content to the earpieces in that format. In that case, the software would of course preferably be configured to split the wave files into left and right tracks, and only download the corresponding tracks to the respective earpieces so that each earpiece would only contain one side (i.e., left or right) of all audio. And also in that case, the earpieces' audio playback modules could omit decoding functions for mp3 or the like, reducing complexity and processing energy, and increasing speed. If decoding functions are included in the circuitry, however, they are preferably embodied within a high-performance ASIC 72 along with other modules. (For example, Atmel Corp. of San Jose, Calif.'s AT83SND2CMP3, though not specifically tailored for inclusion in the present invention, provides an example of a 9 mm×9 mm×9 mm chip incorporating functions including hardwired MP3 decoding, MP3-player control, stereo audio DAC, and mono audio power amplifier for speaker control).

The foregoing detailed description of an embodiment of the invention is provided in order to simplify explanation of the invention, but it will be recognized that an earpiece according to the present invention can likewise be configured to rebalance the center of mass of the body with respect to the anchor, and/or to more compactly and ergonomically fit the earpiece to an ear (e.g., in the shape of a hearing aid) by reconfiguring the components and decreasing their size and altering their shape, and/or to suit other design objectives such as different interface control methods and layout. In that regard, overall earpiece size may be conveniently reduced and/or performance and capacity increased through various means known in the art such as by using a higher-energy density power source (e.g., one based on Electrovaya, Inc.'s lithium polymer technology disclosed in U.S. Pat. Nos. 6,753,114 and 7,033,702 and U.S. Patent App. Publication No. 2004/0175626, the pertinent teachings of which are incorporated herein), by moving further circuitry with the controller onto an ASIC, by optimizing the circuitry and the code loaded on it for low energy consumption, etc. Also, selected code and/or other large non-audio data could be stored on the same onboard memory chip that is used to store the audio data (using, e.g., Samsung OneNAND Flash memory Part No. KFW8G16Q2M-DEBx−8 Gb, 1.8V, 10 mm×13 mm×1.4 mm 63FBGA (LF), available at the time of filing as engineering samples).

In an embodiment with a transceiver onboard each earpiece, the interface controls could optionally be split between the master and slave, for example with volume controls provided on the outer face of the slave unit (e.g., the user's left ear) and the forward/play/reverse controls provided on the outer face of the master unit (e.g., the user's right ear), in which case both the master and slave would be configured to send all three types of signal (command, timing, and confirmation). In that way, the system's overall required interface control surface area could be reduced, and finding the appropriate controls without sight would be facilitated for the user.

Optionally, the personal audio player could include circuitry and an additional control to permit the user to cause the earpiece(s) to orally read out information (derived directly from the song files and/or through other means) pertaining to the audio piece being played (and/or queued) such as the name of the piece, its artist, album, etc., preferably with automatic pausing of any playback during such readout (or rather than adding another control, the circuitry could be configured to perform the read-out in response to the pause command). Alternately, in an embodiment in which the overall earpiece size could be increased without significant disadvantage, the personal audio player may further include a visual display for such information. Another optional feature that could be added to many possible embodiments is an FM radio receiver, with corresponding rudimentary slewing up and down controls and a fourth position provided on the slider control to permit the selection of radio. As another alternative, a slave earpiece that does not store the audio content could be used, with audio conveyed to the slave earpiece from the master earpiece either by the transmitter to receiver or by wire.

Although the present invention has been described in detail in the context of a preferred embodiment of a personal audio player, one skilled in the art will appreciate that numerous variations, modifications, and other applications are also within the scope of the present invention. For example, aspects of the invention disclosed herein could be employed in remote control for use with digital video recorders, to synchronize playback using a synchronization protocol suitably adapted to cause multiple digital video recorders (for example, two units in different rooms of a house) having the same A/V content to playback that content in synchronicity, optionally with a clock onboard the remote control to keep track of playback time, so that the digital video recorders would not need to send time of playback information except in response to signals transmitted to them by the remote control. Thus, the foregoing detailed description is not intended to limit the invention in any way, which is limited only by the following claims and their legal equivalents.

Certain terms particularly used in the following claims are clarified as follows: “persistent memory” refers to the type of memory that persistently retains the information stored on it after power is turned off; “multiple songs” shall mean the amount of data required to represent at least twenty minutes of music content at so-called “FM-quality”; “circuitry” refers to electronic components as well as the firmware and/or software code loaded on them; a “module” refers to any combination of hardware, firmware, and/or software; and “audio playback” is limited to audio content that is pre-recorded (which does not include content obtained from a non-onboard source (e.g., via a microphone or FM receiver) for playing in real-time or in substantially real-time through buffer storage).

1-26. (canceled)

27. A personal audio player system for a human user having a first ear and a second ear, comprising:
a) a first earpiece comprising:
i. a body;
ii. an anchor attached to said body and having a shape that permits it to firmly secure to the user's first ear;
iii. an onboard audio speaker;
iv. onboard persistent memory having a storage capacity adequate to store multiple songs;
v. an onboard power source;
vi. onboard interface controls; and,
vii. onboard electronic circuitry; and,
b) a second earpiece not connected to said first earpiece by wire, said second earpiece adapted to emit audio in synchronicity with said first earpiece and comprising:
i. a body;
ii. an anchor attached to said body and having a shape that permits it to readily secure to the user's second ear;
iii. an onboard audio speaker; and,
iv. an onboard power source.

28. The system of claim 27, wherein said first earpiece further comprises an onboard transmitter and said second earpiece further comprises an onboard receiver.

29. The system of claim 28, wherein said first earpiece further comprises a receiver and said second earpiece further comprises a transmitter, and wherein said first earpiece comprises one or more interface controls adapted to control said second earpiece and said second earpiece comprises one or more interface controls adapted to control said first earpiece.

30. The system of claim 28, wherein said first earpiece and said second earpiece are configured to securely attach to each other for transport and storage as a single item.

31. The system of claim 28, wherein said second earpiece further comprises onboard persistent memory having a storage capacity adequate to store multiple songs and further comprises onboard electronic circuitry comprising an audio playback module.

32. The system of claim 31, wherein said second earpiece further comprises onboard volume controls.

33. The system of claim 31, further including a separate computing device configured and/or programmed to load audio content onto said onboard persistent memories of said earpieces such that left and right audio tracks are stored exclusively on the corresponding earpieces.

34. The system of claim 33, wherein said system is configured and/or programmed to load said audio tracks to said earpieces in waveform (.wav) or equivalent uncompressed format.

35. The system of claim 31, wherein said onboard circuitry of said first earpiece and said onboard circuitry of said second earpiece each further comprise a synchronization module.

36. The system of claim 35, wherein said synchronization module of said first earpiece is configured and/or programmed to provide synchronization signals to said transmitter and said synchronization module of said second earpiece is configured and/or programmed to process synchronization signals received from said receiver, wherein said synchronization signals correspond to the selection and/or progress of audio content playback by the first earpiece.

37. The system of claim 35, wherein said transmitter is configured to transmit synchronization signals periodically rather than continuously, or at a frequency below microwave.

38. The system of claim 36, wherein said transmitter is configured to transmit synchronization signals periodically rather than continuously, and at a frequency below microwave.

39. The system of claim 36, wherein said first earpiece further comprises a receiver and said second earpiece further comprises a transmitter.

40. The system of claim 39, wherein said second earpiece is configured and/or adapted to transmit confirmation signals to said first earpiece in response to successful receipt of said synchronization signals from said first earpiece.

41. The system of claim 40, wherein said system is configured and/or programmed so that commands are not implemented until said command synchronization signals are confirmed.

42. A personal audio player system adapted to play synchronized audio, comprising:
a) a first earpiece comprising:
i. a body;
ii. an anchor attached to said body and having a shape that permits it to readily secure to a single human ear without need for support from a second ear or other part of the head not adjacent the ear to which it is secured;
iii. an onboard audio speaker;
iv. onboard persistent memory having a storage capacity adequate to store multiple songs;
v. an onboard power source;
vi. onboard interface controls;
vii. onboard electronic circuitry; and,
viii. means for conveying synchronization signals; and,
b) a second earpiece not connected to said second earpiece by wire, said second earpiece comprising:
i. a body;
ii. an anchor attached to said body and having a shape that permits it to readily secure to a single human ear without need for support from a second ear or other part of the body not adjacent the ear to which it is secured;
iii. an onboard audio speaker;
iv. an onboard power source; and,
v. means for receiving synchronization signals.

43. The system of claim 42, wherein said first earpiece further comprises an onboard transmitter and said second earpiece further comprises an onboard receiver.

44. The system of claim 43, wherein said first earpiece further comprises a receiver and said second earpiece further comprises a transmitter, and wherein said first earpiece comprises one or more interface controls that control said second earpiece and said second earpiece comprises one or more interface controls that control said first earpiece.

45. The system of claim 43, wherein said second earpiece further comprises onboard electronic circuitry and onboard persistent memory having a storage capacity adequate to store multiple songs.

46. The system of claim 45, further including a separate computing device configured and/or programmed to load audio content onto said onboard persistent memories of said earpieces in waveform (.wav) or equivalent uncompressed format.

47. The system of claim 45, wherein said onboard circuitry of said first earpiece and said onboard circuitry of said second earpiece each further comprise a synchronization module.

48. The system of claim 42, wherein said means for conveying synchronizing signals is configured to transmit synchronizing signals periodically, and at a frequency below microwave.

49. A personal audio player system comprising a first earpiece that comprises:
a) a body;
b) an anchor attached to said body, said anchor comprising a pliable material and having a shape that conforms to the canal of a human ear adequately so that said anchor can be conveniently inserted within a human ear canal securely enough to support said body without need for support from behind the ear;
c) an onboard audio speaker;
d) onboard persistent memory having a storage capacity adequate to store multiple songs;
e) an onboard power source;
f) onboard interface controls including the functions of volume up, volume down, play, forward, and reverse; and,
g) onboard electronic circuitry comprising an interface module and an audio playback module.

50. The system of claim 49, further including a control including the following settings: off, continuous play, and shuffle.

51. The system of claim 49, wherein said body has an outer face that is exposed when said anchor is in an ear, and one or more of said onboard interface controls are located on said outer face.

52. The system of claim 49, further comprising an onboard data and charging port and an I/O module, wherein neither said onboard persistent memory nor said onboard power source is removable, and wherein said onboard persistent memory has a storage capacity of at least 1 Gb.
